(19) United States
(12) Patent Application Publication
(10) Pub. No.: US 2016/0279925 A1
(43) Pub. Date: Sep. 29, 2016

(54) GRAVURE PRINTING PRESS, AND PRINTING SYSTEM HAVING A GRAVURE PRINTING PRESS

(71) Applicant: KOENIG & BAUER AG, Würzburg (DE)

(72) Inventors: Volker SCHARKUS, Würzburg (DE); Volkmar SCHWITZKY, Würzburg (DE); Alain WÜRSCH, La Tour-De-Peilz (CH); Benjamin ZIEROLD, Höchberg (DE)

(21) Appl. No.: 15/034,573

(22) PCT Filed: Jul. 29, 2014
(86) PCT No.: PCT/EP2014/066238

§ 371 Date: May 5, 2016

(30) Foreign Application Priority Data
Nov. 21, 2013 (DE) 102013223826.6

(51) Int. Cl. B41F 9/08

(52) U.S. Cl. CPC B41F 9/08

(57) ABSTRACT

A gravure printing press utilizes a printing assembly with a printing forme cylinder that is twice as large in relation to the number of multiple copies which can be printed during one revolution. The printing forme cylinder, in a thrown-on position, forms a printing point with an impression cylinder which is twice as large in relation to the number of multiple copies which can be printed during one revolution. A wiping cylinder, in a thrown-on position, also interacts with the printing forme cylinder. An ink collecting cylinder, in its thrown-on position, interacts with the printing forme cylinder. A plurality of stencil cylinders, in thrown-on positions, interact, one after another, with the ink collecting cylinder on the circumference thereof. Each of the stencil cylinders can be inked by at least one inking unit. The ink collecting cylinder is configured with a circumference which is larger than the printing forme cylinder by an integral multiple.

### CROSS REFERENCE TO RELATED APPLICATIONS

This application is a U.S. National Phase, under 37 USC 371, of PCT/EP2014/066238, filed Jul. 29, 2014, published as WO2015/074773A1 on May 28, 2015 and claiming priority to DE 10 2013 223 826.6, filed Nov. 21, 2013, the disclosures of which are expressly incorporated herein by reference.

### FIELD OF THE INVENTION

The present invention relates to gravure printing presses and to a printing system having a gravure printing press, in particular for printing sheets of securities. The gravure printing press includes a printing assembly having a printing forme cylinder which is double-sized in terms of a number of copies which can be printed during one revolution. The printing forme cylinder, in the thrown-on position, forms a print position with an impression cylinder which is double-sized in terms of the number of copies that can be printed during one revolution. A wiping cylinder, in the thrown-on position, cooperates with the printing forme cylinder. An ink collecting cylinder, in the thrown-on position, cooperates with the printing forme cylinder. A plurality of stencil cylinders, in the thrown-on position, cooperate, one after the other, with the ink collecting cylinder on the circumference thereof and can each be inked up by at least one inking unit. At least one second printing press, which is embodied as a gravure printing press and having a printing forme cylinder, an ink collecting cylinder and a plurality of stencil cylinders which, in the thrown-on position cooperate one after another with the ink collecting cylinder on the circumference thereof, may be used for printing sheets of securities. The printing forme cylinder and the ink collecting cylinder have the same circumference having at least triple the circumferential length of the circumference of the stencil cylinder.

### BACKGROUND OF THE INVENTION

EP 0 563 007 A1 discloses an intaglio printing press having three frame sections, wherein an impression cylinder, a printing forme cylinder having two printing plates arranged one in front of the other, and a wiping cylinder are provided in a first frame, an ink collecting cylinder is provided in the second frame, and the three inking units, each having one stencil roller for inking up the ink collecting cylinders in an operating position for collect-run gravure printing are provided in a third frame. For the operating position used for direct gravure printing, the center frame is removed. Impression cylinder, plate cylinder and ink collecting cylinder have the same circumference. This printing press is particularly advantageous in terms of its embodiment as a proof printing machine.

DE 690 08 941 T2 is directed to improving the prior art intaglio printing press for printing securities, in which a small ink collecting cylinder cooperates with a larger intaglio plate cylinder in an Orlof process. In DE 690 08 941 T2, the ink collecting cylinder is the same size as or larger than the plate cylinder. This is meant to ensure that the same zones on the ink collecting cylinder always come exactly into contact with the same zones on the plate cylinder. Moreover, since the plate cylinder is generally required to carry at least two, preferably three or four engraved plates, the diameter of the plate cylinder and that of the ink collecting cylinder are relatively large. For a plate cylinder carrying three plates, the diameter is 840 mm, for example, which corresponds to a circumference of just under 2,640 mm, or approximately 880 mm per segment. As a result of this large diameter, less compressive force is required in the band of contact, and the separation behavior is more advantageous. In the described example, ink collecting cylinder, plate cylinder and printing cylinder have the same three-segment circumference having a diameter of 840 mm. On the circumference of the three-segment ink collecting cylinder, the same number of selective inking cylinders are provided as different colors are used, in the example four. In one variant, it is also possible for the circumference of the ink collecting cylinder to be two or even three times as large as the circumference of the plate cylinder if a reduced dimension of the plate cylinder allows such a size of the ink collecting cylinder for practical reasons.

EP 1 602 482 A1 discloses an intaglio printing press having a two-segment ink collecting cylinder which cooperates with four stencil cylinders. The ink collecting cylinder, printing plate cylinder and impression cylinder, each embodied as comprising two segments in the circumferential direction, are arranged in a line for the purpose of decreasing vibrations.

EP 2 150 412 B1 relates to a printing press system for recto-verso printing, in which two presses are provided, each for printing on a single side in an intaglio printing process. In the embodiment example for the system, each of the printing presses is embodied as having triple-sized ink collecting cylinder, plate cylinder and printing cylinder, in other words in a 3:3:3 circumferential ratio; any other whole number circumferential ratios are also possible, however ratios of the numbers 1 to 5 are advantageous, with 1 to 3 being particularly advantageous. In the embodiment example having the triple-sized cylinders, the three-segment ink collecting cylinder is inked up by interacting with five inking units on its periphery.

From a chapter of the “Handbook of Print Media” by Helmut Kipphan, Springer, 2000, relating to security printing, a printing unit of a security printing press having an Orlof steel engraving unit is known, in which a two-field or two-segment letterpress forme cylinder as the ink collecting cylinder is inked up with multiple colors by four inking units, and the steel engraved plates of a three-field plate cylinder are inked up in the Orlof process.

EP 2 253 468 A2 discloses a gravure printing press having a triple-sized printing forme cylinder, which in one embodiment cooperates with a quadruple-sized ink collecting cylinder, and in another embodiment cooperates with a triple-sized ink collecting cylinder. For maintenance purposes, a frame section that supports the inking units can be moved away from the main frame.

From WO 2011/077350 A1, a gravure printing press having triple-sized plate, ink collecting and impression cylinders is known, wherein the ink collecting cylinder and five stencil cylinders for inking up said cylinder are held in a first frame section that can be backed away from the main frame, and the inking units for inking up the stencil cylinders are held in a second frame section that can be backed away from the first frame section, which can also be backed away. The frame sections that can be backed away are supported suspended from a support frame so as to be movable accordingly. In a first embodiment, during operation, the cylinders and inking units of the gravure printing press are driven together in part by a main motor via detachable drive connections, and for maintenance purposes they are driven in part via auxiliary drives. In a second embodiment, the ink collecting cylinder and the stencil cylinders are also driven via separate drive motors during operation, and in a third embodiment, the inking units are also driven via at least one separate drive motor.

EP 1 743 768 A2 discloses a collect offset printing press for simultaneous duplex printing, in which on both sides of the press frame that accommodates the printing unit cylinders, an inking unit frame can be moved toward and backed away from the press frame. Individual cylinders or groups of cylinders or rollers of the separable frames are driven by independent drive motors, thereby preventing leaks that might otherwise occur in the drive interfaces. The corresponding areas of the gearboxes are completely closed.

EP 2 392 461 A1 relates to a method and a device for adjusting the contact pressure of a wiping cylinder against a plate cylinder of a gravure printing press by means of the driving torque of the motor that drives the wiping cylinder. A wiping unit that comprises the wiping cylinder can be moved laterally out of the press through an opening in the side frame on the operating side.

EP 1 995 062 A1 discloses a printing press system for duplex printing of sheets according to an intaglio printing method. Impression cylinder, forme cylinder and collect cylinder preferably have, for example, the same diameter, with each having a triple diameter in the case presented. Other ratios are also possible, e.g. specifically 2:3:2, 2:3:3, 2:2:2, 3:3:4, 3:4:4, 4:4:4, etc. In principle, any whole number ratios x:y:z are possible, with x, y and z being chosen from 1, 2, 3, 4, 5 or even greater numbers.

EP 2 338 682 A1 discloses a gravure printing press in which a first frame section that supports an ink collecting cylinder and a plurality of stencil rollers can be backed away from a frame that supports a gravure forme cylinder and an impression cylinder. An inking unit frame that supports a plurality of inking units can in turn be backed away from the first frame section.

The subsequently published EP 2 835 257 A2 relates to an intaglio test printing press, in which an ink collecting cylinder is embodied as quadruple-sized, a printing forme cylinder is embodied as double-sized, and an impression cylinder is likewise embodied as double-sized.

### SUMMARY OF THE INVENTION

It is the object of the present invention to devise gravure printing presses, in particular for security printing, and a printing system that comprises the gravure printing press.

This object is attained according to the invention by the provision of the ink collecting cylinder as having a circumference which is a whole number multiple of the circumference of the printing forme cylinder. The circumferential length of the printing forme cylinder is, at most, 1,600 mm. The printing system is configured having the first printing press cylinder as a first gravure printing press and cooperating with the at least one additional printing press, which is also configured as a gravure printing press.

The advantages to be achieved by the present invention consist particularly in the provision of a printing press for security printing that is compact and easy to operate for printing small print runs and/or for test printing before printing of a high-volume print run.

The printing press is characterized particularly in that even small runs and/or proof printing can be produced economically, at reasonable cost, with a quality comparable to high-quality final print production. The relatively high cost and the time required to produce gravure printing formes, especially gravure printing formes for use in security printing, in particular bank note printing, exclude the use of such formes for small print runs and/or the configuration of a press which—as is customary for gravure printing—is designed for printing very large print runs. This press is preferably embodied as having a printing forme cylinder which—together with a printing forme that will be or has been applied, for example—has a maximum outer circumference of 1,600 mm, for example, advantageously a maximum of 1,400 mm, in particular a maximum of 1,250 mm. For example, it measures between 800 mm and 1,600 mm, advantageously between 900 mm and 1,400 mm, in particular between 1,000 mm and 1,250 mm. In contrast to presses for final print production, a maximum printing width, i.e. a maximum width of the printing forme cylinder that can be used for printing, is between 300 mm and 600 mm, for example, in particular between 350 mm and 500 mm, with the maximum printing material width to be processed being greater than the maximum width that can be used for printing, i.e. the maximum printing width. The small circumference and/or the particularly narrow configuration therefore also result in a significantly smaller printing surface on the forme cylinder than in other gravure printing presses, i.e. also a significantly smaller surface on a steel engraving. The dimensions of the above-stated regions are preferably such that, and/or involve the condition that, the maximum usable area available for printing on the circumference of printing forme cylinder 07, i.e. the total of the printing lengths in the circumferential direction multiplied by the maximum usable width is a maximum of 0.40 m², in particular a maximum of 0.35 m², preferably a maximum of 0.30 m².

The printing press embodied for small print runs and/or for proof printing, particularly also referred to here as a compact printing press, is characterized by measures that permit simple and rapid operation, in particular a simple and/or rapid production change. For this purpose, the frame of the printing assembly can be embodied as comprising multiple sections, so that in or on one frame section, a printing forme cylinder is mounted, and in or on another frame section, a cylinder for inking up the printing forme cylinder, e.g. an ink collecting cylinder, is mounted, wherein the positions of these two frame sections relative to one another in the radial direction of the printing forme cylinder can be changed. In addition or alternatively thereto, printing material to be printed can be fed into the printing assembly from the same side of the printing assembly on which the printed printing material is removed after printing. For this purpose, in one advantageous embodiment, sheet infeed unit and sheet delivery unit can be arranged on the same side relative to the location of the print position.

Of particular advantage is an embodiment in which a printing forme cylinder that is or will be loaded with gravure printing formes is embodied as only a maximum of double-sized, i.e. as having a circumference for holding a maximum of, more particularly precisely two printing formes one in front of the other in the circumferential direction, and/or a circumference for printing two copies or printing lengths per revolution. A cylinder of this type preferably comprises two segments distributed evenly one in front of the other in the circumferential direction, on each of which one printing forme, which is preferably continuous over at least the entire printing width currently to be printed, particularly continuous over the maximum printing width, can be arranged. In one advantageous embodiment, the printing forme cylinder, which is particularly embodied as small, can be loaded with two printing formes, one in front of the other, since the length of the printing forme and thereby a rolling out effect, which occurs to a minor degree during operation, is thereby decreased, particularly by half in relation to a full circumference printing forme. The printing forme cylinder is advantageously embodied, despite a two-segment embodiment, to carry on its circumference only one printing forme, which is provided with the engraving of a print image to be printed, while the other segment preferably remains unoccupied or optionally carries a so-called blank plate.

To ensure a printing quality and/or printing diversity that is comparable to production printing for the compact printing press despite the small circumference of the printing forme cylinder, an ink collecting cylinder that is larger than the printing forme cylinder is provided, which cooperates for its inking up with at least four, preferably five inking unit trains. However, these four or five inking unit trains cooperate with a four-part and/or four-segment ink collecting cylinder rather than with a three-part or three-segment ink collecting cylinder. This results in greater rigidity on the ink collecting cylinder—in relation to the smaller embodiment of the forme cylinder. In addition, two segments of the ink collecting cylinder always coincide with the same segment of the printing forme cylinder. This configuration enables printing without doubling—even if only one half side of the printing forme cylinder is loaded.

With respect to ease of assembly, for example in the embodiment of the printing assembly having a frame that can be separated in at least one location, it is advantageous for at least the frame section that supports the forme cylinder and the frame section that supports the inking units—and if a movable center part is provided, also the frame section that supports the ink collecting cylinder—to be disposed or disposable on a common support frame, e.g. in the manner of a base plate or a support frame. In this case, a slide track can be provided in the overarching support frame by the manufacturer, or can be installed into or onto this support frame on site, without damage to the print shop floor. In principle, a wiping tank unit that can be optionally backed away can likewise be positioned on the support frame or on a separate support frame which is connected to the support frame.

Independently thereof or in addition thereto, this is advantageous for the gravure printing press that operates according to the Orlof process, in which the wiping tank, particularly including wiping cylinder, can be backed away radially from the printing forme cylinder for setup and maintenance purposes. This allows cleaning to be performed efficiently, e.g. between smaller print runs, without high automation or assembly costs. In a preferred embodiment, however, the frame is closed off from the end surface of the cylinder to prevent entry.

### BRIEF DESCRIPTION OF THE DRAWINGS

Embodiment examples of the present invention are illustrated in the set of drawings and will be specified in greater detail in the following.

The drawings show:

FIG. 1 an embodiment example of a printing assembly having a printing material infeed and discharge unit, in a printing press embodied as a compact printing press;

FIG. 2 an enlarged illustration of the cylinders and rollers of the printing assembly of FIG. 1;

FIG. 3 the printing assembly of FIG. 1 and FIG. 2 in a maintenance position;

FIG. 4 a first embodiment example of the drive of the printing assembly;

FIG. 5 a second embodiment example of the drive of the printing assembly;

FIG. 6 a third embodiment example of the drive of the printing assembly;

FIG. 7 a fourth embodiment example of the drive of the printing assembly;

FIG. 8 an embodiment example of the printing press, embodied as a compact printing press and comprising a control unit, a temperature control unit and a product delivery unit;

FIG. 9 an embodiment example of the printing presses in a print shop, having one printing press embodied as a compact or small format printing press and at least one, preferably two printing presses embodied for production printing and/or high-volume printing.

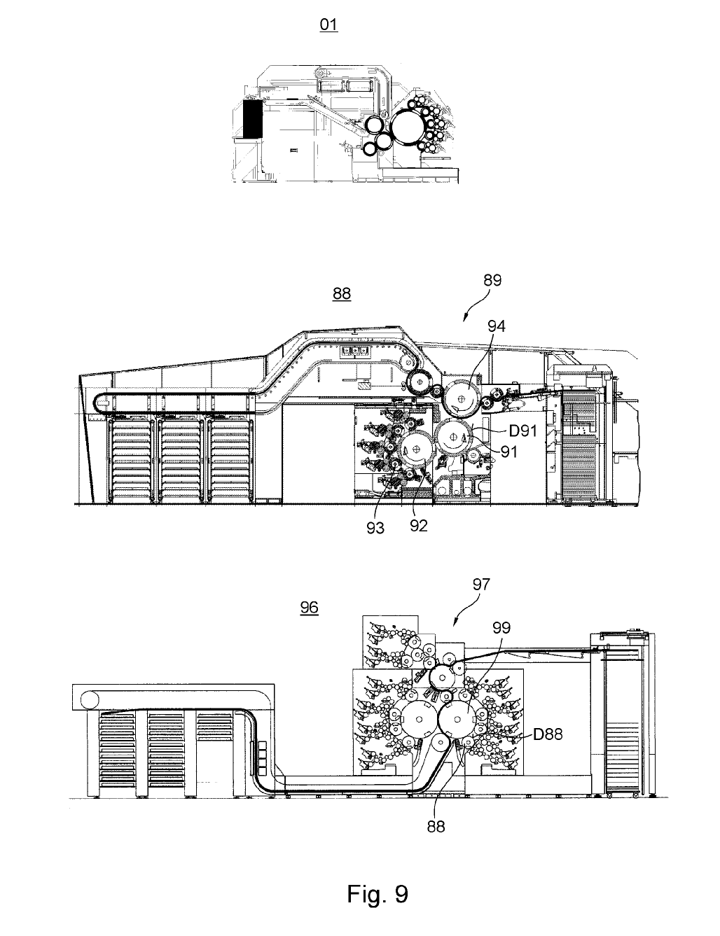

### DESCRIPTION OF THE PREFERRED EMBODIMENTS

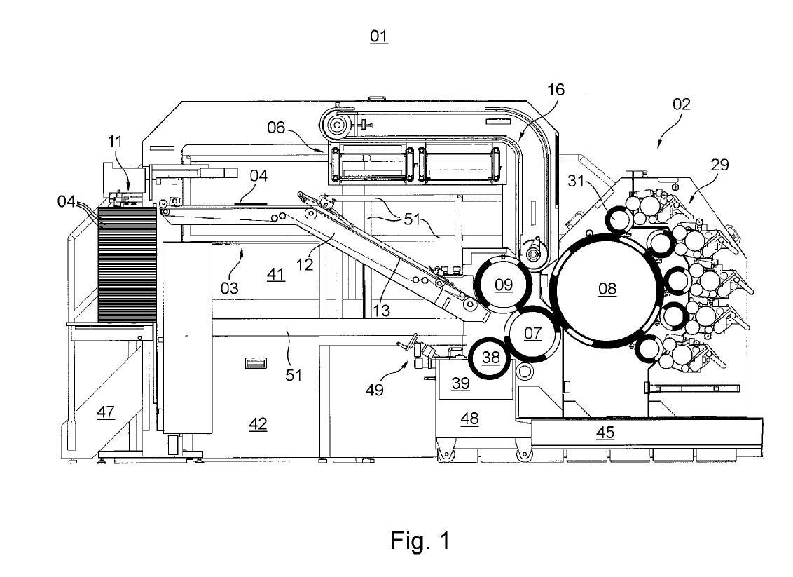

A printing press 01, in particular for printing small print runs and/or for test printing before printing of a high-volume print run, e.g. embodied as a web-fed printing press or preferably a sheet-fed printing press, comprises a printing assembly 02, e.g. a printing device 02, which is supplied on the input side with a preferably sheet-type or web-type printing material 04 by feeding device 03, and by which printing material 04 is printed on one side or both sides in one color or multiple colors, and a product delivery unit 06, where printed products or intermediate products are delivered in the form of a stack or continuously (see, e.g. FIG. 1). In a preferred embodiment illustrated in the figures, printing press 01 is embodied as printing press 01 for security printing, for example for printing web-type printing material 04, e.g. a printing material web, but preferably for printing sheet-type printing material 04, e.g. printing material sheets 04. In this case, feeding device 03 is embodied e.g. as sheet infeed unit 03, in which a stack of the printing material sheets 04 to be infed and printed is and/or can be arranged. Product delivery unit 06 can be embodied as a sheet delivery unit 06 that forms one or more stacks.

In principle, printing assembly 02 of the printing press preferably embodied as security printing press 01 can be embodied as printing assembly 02 which operates based on any printing method and comprises two or particularly more cylinders 07; 08; 09; 31, e.g. printing unit cylinders 07; 08; 09; 31, which roll against one another in pairs in the thrown-on position, however in a preferred embodiment, said printing assembly is embodied for at least single-sided printing based on an Orlof process and/or for at least single-sided printing based on a gravure process, in particular for steel engraving printing (see, e.g. FIG. 1). The expression “thrown-on” refers here and in the following to the relative positioning of the cooperating cylinders 07; 08; 09; 31; 38 and/or rollers 32; 33; 63 that exists during print operation and/or is provided for print operation. Printing material 04 is most preferably embodied as paper, which is formed with textile, linen or hemp fibers, and/or preferably comprises positive and/or negative water marks in the as yet unprinted state.

Printing material sheets 04, which are provided in the preferred case of a sheet-fed printing press, are held in reserve in the form of a stack in feeding device 03, embodied as a sheet infeed unit 03, from which they are removed individually by a gripper device 11, which comprises suction cups, for example, and are conveyed separately via a conveyor path, e.g. a conveyor system 12 embodied as a belt system 12 and having one or more belt sections and/or at least one table 13 close to the intake region of printing assembly 02, for entry into printing assembly 02. At the intake to printing assembly 02, printing material sheet 04 is transferred to a conveyor path assigned to printing assembly 02, e.g. to a conveyor system assigned to printing assembly 02, in which printing material sheet 04, or sheet 04, passes one or optionally more print positions 14 along its transport path before being transferred from the conveyor path assigned to printing assembly 02 to a third conveyor path, e.g. comprising a conveyor system 19 embodied as a belt system 16, and being transported by this path up to product delivery unit 06, e.g. a product delivery unit 06 comprising one or more sheet delivery units for stack formation.

In the preferred case of a sheet-fed printing press, the conveyor path assigned to printing assembly 02 is embodied, e.g. as a gripper system, in which printing material sheet 02 is conveyed over one or more drums and/or cylinders 09, e.g. transport drums and/or transport cylinders 09, in succession in the transport direction, along the transport path through printing assembly 02. In the present case of printing assembly 02 embodied as a printing assembly comprising e.g. only one print position 14 and/or as a printing device 02 for gravure printing, cylinder 09, which functions simultaneously e.g. as transport and impression cylinder 09, has gripper devices 17 in its circumferential region.

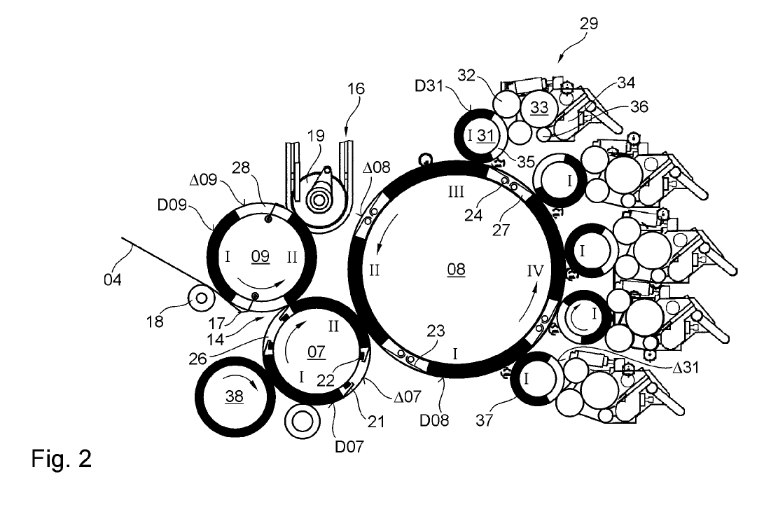

At the end of the conveyor path of feeding device 03 that leads from the sheet stack to printing assembly 02 and/or in the region of the intake into printing assembly 02, e.g. at least one conveyor roller 18 is provided, by which sheet 04 is conveyed in phase to cylinder 09 on the circumference thereof such that the leading edge of sheet 04 is accepted by gripper device 17, indicated only schematically in FIG. 2, and by rotating cylinder 09 in its production direction of rotation (indicated in FIG. 2 by curved arrows) is conveyed through the print position to an output area, where, after printing, it is taken over from gripper device 17 assigned to cylinder 09, via, for example the interconnection of a removal device 19, e.g. a roller 19 having a retaining means, and is transferred to the conveyor path that leads to product delivery unit 06. Table 13 can be embodied as a so-called swing feeder, the movement of which supports a placement true-to-register on cylinder 09, which comprises gripper device 17. Depending on the configuration of the respective conveyor path and/or of printing assembly 02, one or more additional transfer drums may be provided between conveyor system 12 of feeding device 03 and conveyor system 19 to product delivery unit 06.

Cylinder 09, which functions as transport and impression cylinder 09, preferably has on its circumference a number of gripper devices 17, arranged in succession, which number preferably correlates to the “size” of the relevant cylinder 09 based on a printing section length and characterized by the number m (mεIN) of printing section lengths and/or so-called copies on the circumference, with this number corresponding in particular to m (mεIN).

In the following, the “size” of cylinders or printing unit cylinders 07; 08; 09; 31 will also be indicated by the number j; k; l; m (j, k, l, mεIN) of printing section lengths, also referred to as printing lengths or particularly as “copies”, that are or can be provided one in front of the other in the circumferential direction. The printing length or the length of the copy is understood as the length in the circumferential direction which, for the configured printing assembly 02, corresponds to the maximum uninterrupted print image length to be printed by printing assembly 02, as viewed in the transport direction. It may also be referred to as the motif length. Circumferential sections D08; D08; D09, which comprise the respective printing section, can also be referred to as so-called segments I; II; III; IV—regardless of whether or not the circumferential surface is actually embodied as segmented.

The circumferential length U07; U08; U09; U31 of the relevant cylinder 07; 08; 09; 31 then corresponds to at least the total length of the number j; k; l; m of printing lengths D and/or the relevant circumferential sections D07; D08; D09; D31. In the case of a printing material 04 embodied as a web, the circumference can correspond to precisely this overall length. For the preferred embodiment as a sheet-fed printing press 01, circumferential length U07, U08, U09; U31 of the relevant cylinder 07; 08; 09 corresponds, e.g. to the total length of the number j; k; l; m of circumferential sections D07; D08; D09; D31 (e.g. printing sections D7; D8; D9; D31) that can be used for printing, each of which corresponds to at least the printing length D designated for printing press 01 or for printing unit or printing assembly 02, plus one non-printing circumferential section Δ07; Δ08; Δ09; Δ31 between every two printing lengths D and/or printing circumferential sections D08; D08; D09; D31. The latter can be provided as a circumferential section Δ; Δ08; Δ09; Δ31, which continues the surface line but is non-printing, between every two printing lengths D and/or printing circumferential sections D08; D08; D09; D31, for example to account for the offset between two sheets 04 that follow one another during sheet transport and/or an interruption of the closed surface line on another of the cylinders 07; 08; 09; 31. The non-printing circumferential section Δ07; Δ09; Δ31 on the relevant cylinder 07; 08; 09; 31 can also be embodied and conditioned such that, on its circumference, between every two printing sections D07; D08; D09; D31 a depression exists that interrupts the closed surface line. This depression can be accounted for by a seam between two packings 21; 23; 37 or packing ends or packing sections 21; 23; 37 and/or by a channel 26; 27; 28; 35 that holds ends of packings 21; 23; 37 and optionally retaining devices 22; 24 or—in the case of transport cylinder 09—gripper devices 17. Independently of the optionally provided depressions, in the current context the circumferential length U07; U08; U09; U31 is understood as the length along the encompassing surface line that continues the circumferential line uninterrupted.

In the following, a cylinder 07; 08; 09; 31 embodied as specified and having a certain number j; k; l; m of printing lengths D and/or segments I; II; III; IV in the circumferential direction will also be referred to as j-, k-, l- or m-sized—regardless of the configuration thereof with or without circumferential sections Δ07; Δ08; Δ09; Δ31 that interrupt the surface line.

In the present example, which is preferable with respect to a compact and small-format configuration, impression cylinder 09, having a circumference that comprises a maximum of two printing lengths D as described above, i.e. having a single or preferably double circumference, or being single- or particularly double-sized, is also referred to as “double sized”, e.g. with m=2. Its circumferential length U09 corresponds here to one or preferably two printing lengths D plus the two non-printing circumferential sections Δ09, which is or are provided by one, more particularly two channels 26 that hold the gripper devices 17.

Printing assembly 02 is embodied as printing device 02 having a printing unit that prints based on the Orlof process, for example an Orlof gravure printing unit, in particular an Orlof steel engraving printing unit. For this purpose, a printing forme cylinder 07 embodied as forme cylinder 07 cooperates with impression cylinder 09, forming print position 14 in the nip point therewith. In the case illustrated here of single-sided printing, impression cylinder 09, which is disposed on the non-printing side of print position 14 is embodied purely as a printing cylinder 09, also called an impression cylinder. In principle, impression cylinder 09 could also be embodied as a cylinder 09 of a printing unit, in particular an offset printing unit, for printing the other side of printing material 04, in which case printing forme cylinder 07 would then serve as impression cylinder. In both cases, however, impression cylinder 09 is preferably embodied as having a double-sized circumference as described above, or as having two segments I; II in the circumferential direction.

Printing forme cylinder 07 is embodied with respect to a compact and small-format configuration as having a circumference that comprises a maximum of two printing lengths D as described above, i.e. having a single or preferably double or double-sized circumference, i.e. single-sized (I=1) or preferably double-sized (with I=2). In the circumferential direction, it carries one print template, e.g. the engraving, of a print image, the length of which corresponds to the maximum provided printing length D, on one, preferably on each of I=2 printing circumferential sections D07. In the preferred double-sized embodiment, it carries a number I of two such print templates, in particular engravings, one in front of the other, of the same or optionally of two different print images, one in front of the other.

Printing forme cylinder 07 carries the number I, preferably with I=2, of print templates on two printing formes 21 of two printing sections D07. In this case, the print template of the copy, e.g. the print template of printing forme 21 or the two print templates of printing formes 21 and/or printing sections D07, can be provided, in particular engraved, directly onto the circumferential surface of printing forme cylinder 07. Preferably, however, for each printing section length to be printed with one revolution and/or for each printing section D07 provided on cylinder 07, and/or for each copy on cylinder 07, one removable and/or detachable printing forme 21 in the form of a so-called printing plate 21 is and/or can be arranged on the circumference of forme cylinder 07, which carries the print template, in particular the engraving, on its outer surface.

For the preferred case of a sheet-fed printing press, circumferential length U07 amounts to at least the length of one, in this case preferably of two printing lengths D. In the case shown here having printing formes 21 that are or can be fastened in channels 26, circumferential length U07 of forme cylinder 07 amounts to the length of the two printing sections D07 plus the two non-printing circumferential sections Δ07, which are provided by the two channels 26 that accommodate retaining devices 22 for retaining the printing forme ends. One pattern repeat length on forme cylinder 07, i.e. the distance from print start to print start of two successive printing templates, then corresponds to the length of one printing section D07 plus the length of one circumferential section Δ07 that is non-printing and/or cannot be used for printing. Double-sized forme cylinder 07 therefore has a circumference, the circumferential length U07 of which corresponds to two such pattern repeat lengths. In the case of printing forme 21, which as gravure printing forme 21, for example, can easily be more than 0.5 mm thick, the outer circumference has, for example, a maximum circumferential length U07 of, e.g. 1,600 mm, advantageously a maximum of 1,400 mm, in particular a maximum of 1,250 mm. It lies, for example, between 800 mm and 1,600 mm, advantageously between 900 mm and 1,400 mm, more particularly between 1,000 mm and 1,250 mm.

For printing press 01, which is embodied as a compact or small-format gravure printing press 01, a maximum width of forme cylinder 07, i.e. a maximum width that can be used for printing, measures between 300 mm and 600 mm, for example, and particularly only between 350 and 500 mm.

The dimensions in the ranges indicated above for printing length and printing width are preferably provided such that and/or under the condition that the maximum area that can be used for printing on the circumference of printing forme cylinder 07, as configured and ready for operation, i.e. the total of printing lengths and/or possible motif lengths in the circumferential direction multiplied by the maximum width that is usable for the printing template and/or the print motif, is a maximum of 0.40 m², particularly a maximum of 0.35 m², preferably a maximum of 0.30 m².

Printing forme cylinder 07 cooperates—with respect to ink flow—upstream with a printing unit cylinder 08, e.g. ink collecting cylinder 08, which inks up forme cylinder 07 with multiple colors during print operation. This cylinder has, for example, a flexibly and/or compressibly deformable surface, e.g. a surface that is made of rubber. Ink collecting cylinder 08 is embodied with a k-fold (kεIN) circumference, in particular with a circumference that is multiple times, e.g. n-times that of forme cylinder 07, with nεIN and n>1. This ink collecting ink cylinder 08 is preferably embodied as having a quadruple circumference (k=4), for example, and is therefore twice as large (n=2) as forme cylinder 07, which is preferably embodied as double sized (I=2). Especially in connection with the particularly narrow printing forme cylinder 07, the preferably quadruple-sized ink collecting cylinder 08—in relation e.g. to the small printing length—has greater rigidity than a slimmer embodiment, which is advantageous particularly in terms of the channel strike between forme cylinder and ink collecting cylinder 07; 08. It comprises on its circumference k printing sections D08 and/or four segments I, II, III, IV, each of which, in the thrown-on position, rolls against one of the four printing sections D07 and/or segments I, II of forme cylinder 07. The k printing sections can be provided on a circumferential surface that is continuous in the circumferential direction, e.g. a sleeve-like rubber blanket, on a single finite rubber blanket that extends around nearly the entire circumference, or on a plurality of, e.g. on k/2 or, as shown, on k rubber blankets 23 arranged one in front of the other in the circumferential direction. Preferably, however, one detachable printing blanket 23 is and/or can be arranged on the circumference of ink collecting cylinder 07 for each printing section length to be printed during one revolution and/or for each printing section D08 provided on ink collecting cylinder 08 and/or for each copy provided for the cylinder 08, said printing blanket carrying the flexibly and/or compressibly deformable surface on at least its exterior.

For the preferred case of a sheet-fed printing press, circumferential length U08 corresponds to at least the length of k, in particular of four printing lengths D. In the case shown comprising rubber blankets 23 that are or will be secured in channels 27, circumferential length U08 of ink collecting cylinder 08 corresponds to a total of the lengths of k, in particular of four printing sections D08 plus the k, in particular four non-printing circumferential sections Δ08, which are provided by the four channels 27 that accommodate the retaining devices 24 for retaining the rubber blanket ends.

Upstream of ink collecting cylinder 08—with upstream or downstream referring to the direction of the effective ink flow of the printing ink from the ink infeed up to print position 14—the ink collecting cylinder, in the thrown-on or engaged position, cooperates with a number o, oεIN, o>1, in particular o≧4, preferably o=5, of cylinders 31 for inking up the ink collecting cylinder in multiple colors, with said cylinders cooperating with roller trains of a plurality of inking units 29, e.g. a number o, oεIN, o>1, for inking said cylinders up for single-color or optionally dual-color (rainbow) printing. Cylinders 31 that cooperate with ink collecting cylinder 08 are preferably embodied as selective inking cylinders 31, also referred to as stencil cylinders 31, and ink each of the ink collecting cylinders 08 in sequence with at least one printing ink or in the case of rainbow printing, with a combination of printing inks. They are provided on their surface with stencils 37, e.g. in the manner of a letterpress forme having a relief of a contour, corresponding to the relevant color or color combination, for the color pattern of the sections of the print image that relate to this color or color combination. In principle, stencil cylinders 31 can each be part of an inking unit 29 of any configuration, and can each be inked up by a corresponding roller train. In the embodiment that is preferred here, however, inking units 29 are embodied as so-called short inking units 29, and stencil cylinders 31 are inked up upstream in the thrown-on position by one or preferably by a plurality of rollers 32, e.g. two, in particular ink forme rollers 32, which in turn receive the ink from an additional roller 33, e.g. ink fountain roller 33.

Ink fountain roller 33 cooperates with an ink source 34, e.g. an ink fountain 34. On the circumference of ink fountain roller 34, at least one oscillating roller 36, e.g. distribution roller 36, can also be provided. The printing ink is therefore applied by ink fountain roller 33 via two ink forme rollers 32 to the receiving areas of the assigned stencil cylinder 31, which transfer the pattern of the relevant color or color combination predefined by stencil 37 onto printing sections D08 of ink collecting cylinder 08. From there, the print image regions or positions on printing forme cylinder 07 are inked up according to the pattern predefined by stencil 37.

In a compact and small-format configuration, stencil cylinders 31 are preferably embodied as having a circumference that comprises only one printing length and/or one copy as described above, i.e. having a single-sized circumference, i.e. j-sized, with jεIN, j=1. In the circumferential direction, it carries, on one circumferential section D31, the length of which corresponds to the maximum provided printing length, stencil 37 for the color pattern of the color regions of the print image to be printed in multiple colors using the relevant printing unit.

In principle, stencil 37 can be provided with the color pattern that corresponds to a printing section D31, directly on the circumferential surface of the stencil cylinder 31, which in that case is embodied, e.g. as a positively driven roller, in particular by raised areas in an outer circumferential layer of an otherwise engraved circumferential surface of the roller in question. Preferably, however, for the printing section length to be printed during one revolution and/or for the printing section D31 provided on cylinder 31, and/or for each copy, in particular for the one copy, a removable stencil 37, e.g. in the form of a flexible plate 37, is and/or can be arranged on the circumference of stencil cylinder 31.

For the preferred case as a sheet-fed printing press, circumferential length U31 amounts to at least the length of one printing length D. In the case described here having stencils that are or will be secured in channels 35, circumferential length U31 of stencil cylinder 31 corresponds to the length of printing section D31 plus the non-printing circumferential section Δ31, which is determined by channel 26 that accommodates the retaining device for retaining stencil 37.

Independently of the embodiment of cylinders 07; 08; 09; 31 in a press for sheet-fed printing, and independently of whether non-printing circumferential sections Δ07; Δ08; Δ09; Δ31 are accounted for by a channel 26; 27; 28; 35 of the cylinder in question and/or of another of cylinders 07; 08; 09; 31 and/or by the separation of the conveyed sheets 04, the circumferential lengths U07; U08; U31; U09 at least of forme cylinder 07, ink collecting cylinder 08 and stencil cylinder 31, and preferably also of impression cylinder 09 correspond to a whole number multiple, in particular a single-digit whole number multiple of the pattern repeat length, with the whole number i in each case preferably being one of the numbers i=1, 2, 3 or 4.

Circumferential length U07 of forme cylinder 07 and preferably also the circumferential length of impression cylinder 09 preferably corresponds to two pattern repeat lengths, the circumferential length of ink collecting cylinder 08 corresponds to four pattern repeat lengths, and circumferential length U31 of each of stencil cylinders 31 corresponds to precisely one pattern repeat length.

During operation, impression cylinder 09, forme cylinder 07, ink collecting cylinder 08 and stencil cylinder 31 roll off against one another in pairs, substantially without slip.

An additional cylinder 38, e.g. a wiping cylinder 38, preferably cooperates with the circumferential surface of forme cylinder 07 and, in the thrown-on position, removes the excess ink, in particular the printing ink located outside of the engraving on the surface. For this purpose, wiping cylinder 38 preferably rotates in the same direction of rotation as the production direction of rotation of forme cylinder 07. It has, e.g. a circumferential surface, the circumferential surface being made of plastic, for example, and being in physical contact, at least via a thin film of liquid, with the surface of printing forme 21 disposed on forme cylinder 07 such that the surface that is located outside of the engraving is freed of any printing ink. On the other side, wiping cylinder 38 is in contact with a washing fluid reservoir, which removes the printing ink that is removed from forme cylinder 07 from the circumferential surface of the wiping cylinder. For this purpose, the wiping cylinder can dip into a washing fluid and may optionally also be wiped off by suitable devices, e.g. a doctor blade and/or brushes. The washing fluid is held in reserve, for example, in a fluid container 39, e.g. a washing tank 39, into which wiping cylinder 38 dips partially for cleaning.

Wiping cylinder 38 preferably has a circumferential surface that is uninterrupted in the circumferential direction and/or can have a circumference that is not equal to a single-digit whole number multiple of the pattern repeat length. For example, the wiping cylinder has a circumference having a circumferential length U38, which corresponds to 1.4 times to 1.6 times a pattern repeat length and/or 0.7 times to 0.8 times the circumferential length U07 of the—in particular double-sized—forme cylinder 07. Wiping cylinder 38 preferably rotates during production operation at a speed that is higher than the forme cylinder speed, for example at a speed that is 1.1 times to 1.4 times, preferably 1.2 times (±5%) the forme cylinder speed. During operation, a relative speed is preferably present in the nip point between the surfaces of printing forme 21 and wiping cylinder 38 that corresponds to at least twice the circumferential speed that is present on the outside of printing forme 21 disposed on forme cylinder 07.

In a preferred embodiment of the printing press as a compact press, the press is embodied such that printing material 04 to be printed is infed into printing assembly 02 from the same side of printing assembly 02 on which the printed printing material 04 is discharged after printing. For this purpose, sheet infeed unit 03 and product delivery unit 06 are arranged on the same side relative to the location of print position 14. As is clear from FIG. 1, for example, at least one section of conveyor system 12 that is used for printing material infeed and one section of conveyor system 16 that is used for printing material discharge are arranged one above the other on the same side as print position 14, such that they intersect the same vertically extending plane. Product delivery unit 06 is preferably disposed at a higher level than the printing material store and can be accessed, for example, via an operating plane 41, e.g. via a catwalk plane 41 that is higher than a floor plane 42, e.g. via a staircase 47. Conveyor system 12 for infeed, and the conveyor system for discharge are disposed in a frame 51, e.g. in a multi-section support structure or frame structure 51, i.e. composed of a plurality of interconnected carriers and supports. This frame structure is connected e.g. to a press frame 43, in the case of a multi-section embodiment particularly to the first frame section 43.1, in a non-tensile and compressively rigid manner.

A press frame 43, or frame 43, that supports cylinders 07; 08; 09; 37 of printing assembly 02 can, in principle, be embodied as a single section or as a plurality of frame sections securely interconnected in an integral manner, i.e. as one cohesive frame 47 at each end surface. Preferably, however, said frame is embodied as a multi-section frame as shown, i.e. as comprising a plurality of frames 43.1; 43.2; 43.3; 43.3, e.g. frame sections 43.1; 43.2; 43.3; 43.4, which are separated from one another, for example, or can be separated from one another during operation for maintenance purposes.

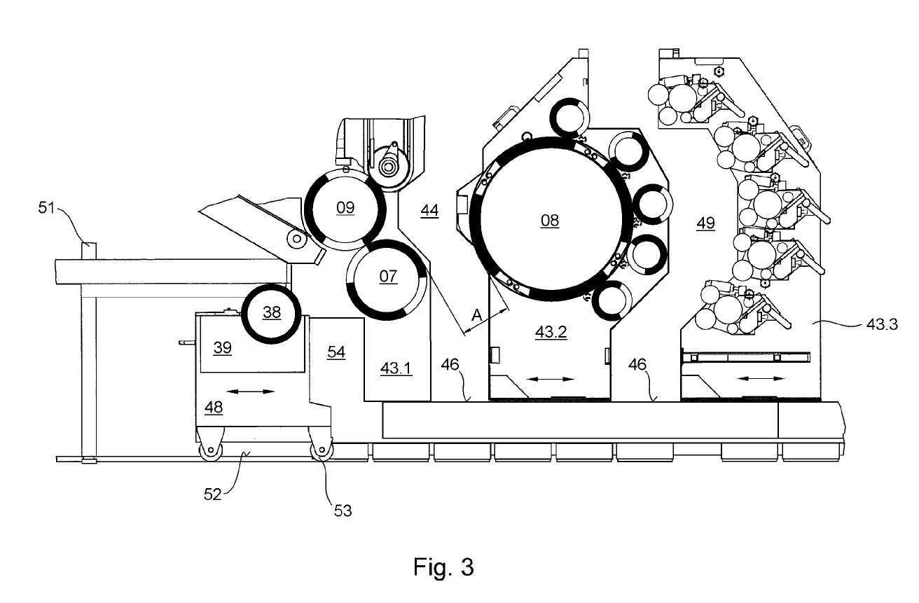

The two cylinders 07; 09 that form print position 14 in this case are a component of a first printing unit section and/or are housed in a first frame section 43.1, e.g. in a main frame 43.1 which is preferably arranged stationary in the printing press. Ink collecting cylinder 08 and the plurality of stencil cylinders 37 are a component of a second printing unit section and/or are housed in a second frame section 43.2. The first and second frame sections 43.1; 43.2 can optionally be brought into a first position relative to one another that forms a working position and into a second position relative to one another that forms a maintenance position, wherein in the maintenance position, a space 44, e.g. maintenance and/or operating space 44, is formed between the first and second printing unit sections and/or the frame sections 43.1; 43.2 that support these, allowing direct access—for example by a press operator—on one side to forme cylinder 07 and on the other side to ink collecting cylinder 08 (see, e.g. FIG. 3).

Although in principle, both frame sections 43.1; 43.2 or first frame section 43.1 can be disposed in the printing press so as to be movable for this purpose, second frame section 43.2 is preferably embodied as movable relative to first frame section 43.1. For this purpose, second frame section 43.2 is mounted so to be movable translationally toward or away from the first frame section 43.1 along a movement path, e.g. over a sliding surface or via rolling elements on a track 46, optionally over a sliding surface of a slide bearing or preferably via rollers on a corresponding track.

For example, means not described in greater detail are provided, by which the two frame sections 43.1; 43.2 can be connected or coupled to one another in the working position. In the working position, second frame section 43.2 is disengaged from first frame section 43.1 and/or is not connected thereto. For coupling, a mechanical locking mechanism is advantageously provided, which is or can be opened and closed by remote operation by means of at least one actuator.

In the working position, forme cylinder 07 and ink collecting cylinder 08 are situated in an operating position relative to one another, i.e. in an operational thrown-on or engaged position, wherein, e.g., in the operational thrown-off position, a distance a between the functional circumferential surfaces of ink collecting cylinder 08 and forme cylinder 07 measures, for example, within the single-digit millimeter range (i.e. for example 0<a<10 mm) and/or a change between the thrown-on position and the thrown-off position is carried out and/or effected without any relative movement of the frame sections 43.1; 43.2. In the maintenance position, in contrast, the circumferential surfaces are spaced from one another radially by a distance A, which is significantly greater, e.g. by at least a factor of 10, preferably by more than a factor of 100, than distance a in the thrown-off position (i.e. for example A>100*a and/or A≧100 mm, in particular). A change between working position and maintenance position is made with and/or by means of a relative movement of the two frame sections 43.1; 43.2.

In principle, inking units 29 can likewise be a component of the second printing couple section and/or can be mounted in second frame section 43.2 and are and/or can be moved along with said frame section. For maintenance purposes, however, inking units 29 are preferably a component of a third printing unit section and/or are mounted in a third frame section 43.3. The positions of second and third frame sections 43.2; 43.3 relative to one another can be changed.

These frame sections can preferably also be optionally brought into a first position relative to one another, which forms a working position, and into a second position relative to one another, which forms a maintenance position, wherein in the maintenance position a space 49, e.g. maintenance and/or operating space 49, is formed between the second and third printing unit sections and/or the frame sections 43.2; 43.3 that support these sections. This allows direct access—for example by a press operator—on one side to stencil cylinders 31 and on the other side to inking units 29 from the inside (see, e.g. FIG. 3). Third frame section 43.3 is likewise mounted, for example, so as to be movable translationally along a movement path, e.g. over a sliding surface or via rolling elements on a dedicated running track 46 or on the same running track, optionally over a sliding surface of a slide bearing or preferably via rollers on a corresponding track, e.g. on the same track or on a continuation of the aforementioned track, toward or away from the second frame section 43.2, and is also referred to as the inking unit carriage. In this case as well, an aforementioned locking mechanism is preferably provided between the two frame sections 43.2; 43.3 in the working position thereof.

In one advantageous embodiment, a logic circuit is provided in a control device, for example, in a software control system and/or a control circuit, and is embodied such that it allows second frame section 43.2 to be moved relative to first frame section 43.1 only if the section frame section is connected to third frame section 43.3, e.g. with the locking mechanism closed, and/or allows a movement of third frame section 43.3 relative to second frame section 43.2 only with an existing coupling, e.g. with the locking mechanism closed, between first and second side frames 43.1; 43.2.

In an advantageous enhancement, in a control device, for example in a software control system and/or a control circuit of the press, a logic circuit is implemented or provided, and is embodied such that it allows a start and/or operation of the press only when frame sections 43.1; 43.2; 43.3 or printing unit sections are located in the working position and/or when the locking mechanism between the first and second frame sections, and in the case of a third separable printing unit section, the locking mechanism between the second and third frame sections 43.1; 43.2; 43.3, is closed. For the purpose of monitoring the working position and/or the status of the locking mechanism, sensors that are signal connected to the stated control device can be advantageously provided.

During a change of a printing forme 21 on forme cylinder 07, with the printing press in idle mode, first the locking mechanism between first and second frame sections 43.1; 43.2 is released, particularly by means of a remotely operated actuator, by means of the press control system or a control routine implemented therein, and/or initiated at an operator interface, e.g. a control console, connected to said controller. Once the locking mechanism has been released, the first and second frame sections 43.1; 43.2 are moved in terms of their relative position from the working position to the maintenance position, e.g. by activating a drive, for example a motorized threaded drive or a cylinder-piston system that can be actuated by compressed medium, via a corresponding control routine, for example, in which maintenance position they are spaced further from one another, forming the space 44 between them that is accessible to press operators, for example. This is preferably accomplished by moving second frame section 43.2 (together with the optionally provided third frame section 43.3), while first frame section 43.1 remains stationary. Forme cylinder 07, which is already unloaded or which has been freed in a further working step via space 44 of any printing forme 21 from a production run that may have preceded the run in question, is then loaded with at least one printing forme 21 for the pending production run. After being loaded, the first and second frame sections 43.1; 43.2 are moved from the maintenance position back to the working position relative to one another by activating the same drive or an additional drive by means of the control routine, the lock between first and second frame sections 43.1; 43 is reestablished, and finally the press is started by means of a press control system, for example initiated by a command that is input at the user interface. However, the start is implemented by the press control system based on a signal status of a sensor that monitors the working position of the frame sections 43.1; 43.2, in particular of second frame section 43.2, and/or the status of the lock, or is prevented if a check of the working position and/or locking mechanism produces a negative result.

At least frame section 43.1 that supports forme cylinder 07, frame section 43.3 that supports inking units 29 and, if the movable center section is provided, frame section 43.2 that supports ink collecting cylinder 08 preferably are or can be arranged on a common support frame 45, e.g. in the manner of a base plate 45 or a support frame 45. In this case, running track 46 can be provided by the manufacturer during production in this overarching support frame 45, e.g. base plate 45 or support frame 45, or can be installed therein or placed thereon on site, without requiring that costly work be performed for this purpose by the customer on the shop floor. This can be advantageously and easily carried out particularly in connection with printing press 01 embodied as compact printing press 01.

In a preferred embodiment of gravure printing press 01, which is not limited to what has been otherwise described but which is particularly advantageous due to its ease of handling, fluid container 39, in particular washing tank 39, is provided on a separate frame 48, e.g. a fourth frame section 48, such that the fluid container is and/or can be separated from the frame 43; 43.1 that supports forme cylinder 07. This frame 48 that is movable relative to frame 43; 43.1 that supports forme cylinder 07, e.g. as a washing tank unit 48, can be brought as a whole into a first relative position that forms a working position and into a second relative position that forms a maintenance position, wherein in the maintenance position, at least one space 54 is formed between washing tank unit 48 and the remainder of printing assembly 02 and/or the frames 48; 43; 43.1 that support said assembly. This space allows direct access—for example by a press operator—on one side to forme cylinder 07, but particularly to wiping cylinder 37. In this connection, washing tank unit 38 can preferably be pushed back out of its working position in a radial direction of forme cylinder 07. In addition, after washing tank unit 38 has been pushed back into its maintenance position, it can optionally be removed completely from the press alignment toward the side. Frame 48 that supports wiping cylinder 38 can preferably be pushed back toward the side of forme cylinder 07 that faces away from ink collecting cylinder 08. Fourth frame section 48 and/or washing tank unit 48, for example, is likewise mounted, for example, such that it can be moved translationally along a movement path, e.g. over a sliding surface or via rolling elements on the same or a separate running track 46; 52, optionally over a sliding surface of a slide bearing or preferably via rollers 53 on a corresponding track, e.g. on or in a track, toward or away from first frame section 43.1. In this case as well, a locking mechanism is preferably provided for the purpose of coupling. Particularly if wiping cylinder 37 is part of washing tank unit 48, an adjustment device 49 as indicated by way of example in FIG. 1 is preferably provided, by which washing tank unit 48 as a whole and/or particularly wiping cylinder 37 can be adjusted and/or aligned with respect to its distance from the circumferential surface of forme cylinder 07. In an advantageous embodiment, washing tank unit 48 comprises wiping cylinder 38, in which case washing tank unit 48 as an entire unit can be removed relative to press frame 43; 43.1 far enough that the aforementioned space 54 can be formed, and such that in the working position, the distance between wiping cylinder and forme cylinder 07; 38 can be adjusted.

For the frames that can be backed away from one another, and particularly also for the frame 48 of wiping cylinder 38, in one preferred embodiment the frames 43.1; 43.2; 43.3; 48, which in the maintenance position are and/or can be backed away from one another, opening up the space between them, form a substantially closed frame 43 in the working position, i.e. they adjoin one another in such a way that they do not permit free access between the two frames 43.1; 43.2; 43.3; 48) that can be backed away from one another. This means that, at the level of printing assembly 02, there is no access to the printing assembly from the operating side.

In an alternative embodiment in which washing tank unit 48 does not also comprise wiping cylinder 38, wiping cylinder 38 can likewise be easily accessed by removing washing tank 48. In this case, wiping cylinder 38 can be mounted on the same frame 43; 43.1 on which forme cylinder 07 is mounted and is preferably also adjustable here in terms of its distance relative to forme cylinder 07.

In a first embodiment, the positively driven cylinders 07; 08; 09; 31; 38 and/or rollers 33 of printing assembly 02 are driven, for example, by a common drive motor 56, e.g. also referred to as main drive 56. For peripheral units, e.g. conveyor drives of conveyor systems 12; 16 or of a gripper device, for example, or actuating drives, secondary or auxiliary drives, not shown here, can be provided. In this embodiment, drive motor 56 works directly on the journal of forme cylinder 07, or on a drive gear 59, e.g. a gear wheel 59 which is rotationally fixedly connected to the journal of forme cylinder 07, via a reduction gear unit 57, e.g. via a belt drive and/or preferably via a gear train comprising at least one sprocket 58. From there, driving is implemented in parallel, for example, on a drive gear 61; 62, e.g. gear wheel 61; 62, which is rotationally fixedly connected to the journal of impression cylinder 09, and on one such drive gear which is rotationally fixedly connected to the journal of ink collecting cylinder 08. The latter can be implemented by means of at least an even number of intermediate gears or preferably directly on gear wheel 62, embodied in this case as “quadruple sized”. Drive gear 62 of ink collecting cylinder 08 further drives drive gears 63, e.g. gear wheels 63, which are connected to the journals of stencil cylinders 31. In the illustrated embodiment, each drive gear 63 of each respective stencil cylinder 31 can be driven via an intermediate gear on a drive gear 64, e.g. gear wheel 64, which is rotationally fixedly connected to ink fountain roller 33 of the assigned inking unit 29.

In the first embodiment, the driving on wiping cylinder 38 is likewise carried out by drive motor 56 on a drive gear 66, e.g. gear wheel 66, which is rotationally fixedly connected to the journal of wiping cylinder 38. In a first variant of sprocket 58 in an embodiment of corresponding size, this driving can be carried out directly or via an even number of intermediate gears, e.g. two (not shown), in parallel with the driving of forme cylinder 07, on the gear wheel. In a preferred variant, this driving is implemented serially by drive motor 56 via drive gear 59 of forme cylinder 07 and an uneven number of intermediate gears, e.g. one intermediate gear 67, on drive gear 66. The stated number of intermediate gears is based on the number of axes required to reverse the rotational direction of two intermeshed gear wheels, so that two gear wheels, rotationally fixedly disposed on the same axle and having different tip diameters, are regarded in this sense as a single gear wheel. The drive train between gear wheel 59 of forme cylinder 07 and the journal of wiping cylinder 38 can preferably be embodied in terms of its rolling ratios and/or by providing an additional gear set 68 such that, taking into account the effective outer circumference of wiping cylinder 38 and that of the loaded forme cylinder 07, forme cylinder and wiping cylinder 07; 38 rotate in the same direction of rotation, and such that a tangential relative speed that corresponds to at least twice, preferably 2.2 times the circumferential speed of forme cylinder 07 is present in the nip point. In principle, the additional gear set 68 can be located between drive gear 66 of wiping cylinder 38 and the journal thereof, but is preferably located in the drive train between drive gear 62 of forme cylinder 07 and drive gear 66 of wiping cylinder 38, and can comprise or replace intermediate gear 67, for example. For the at least speed-controlled operation of drive motor 54, a drive controller 73 is situated upstream thereof, for example.

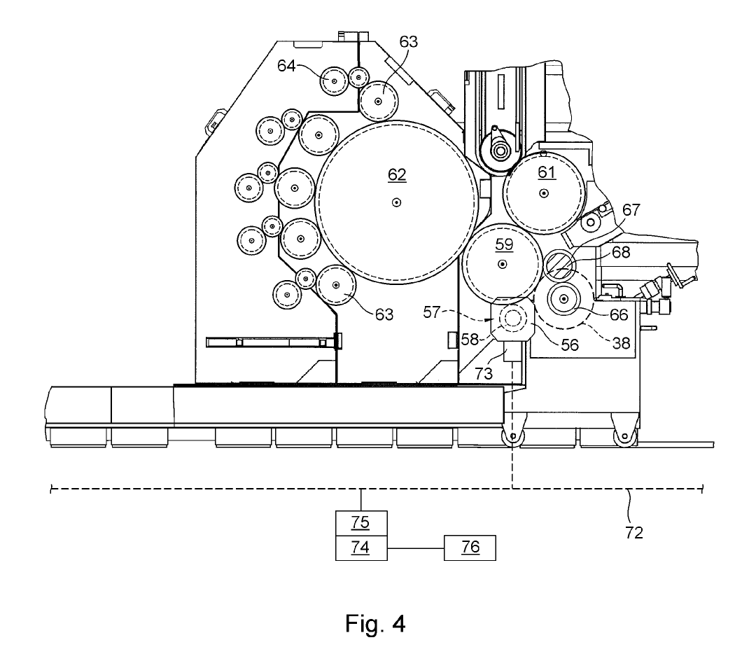

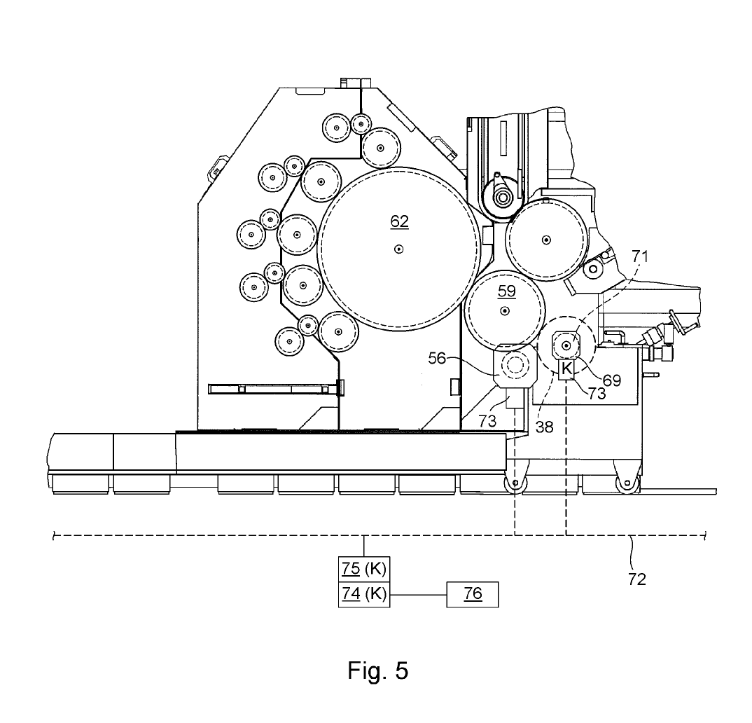

In one variant which is advantageous—particularly in the case of the removable washing tank unit 48—wiping cylinder 38 is driven by a drive motor 69 which is mechanically independent of the remaining cylinders 07; 08; 09; 31 (see, e.g. FIG. 5). This driving can be implemented by the motor shaft, axially directly on the journal thereof, or via a gear set, e.g. a reduction gear unit, indicated by dashed lines. This gear set 71 can be embodied as an axial attachment gear set 71, e.g. planetary gear set. Drive motor 66 can be arranged fixed to the frame on washing tank unit 48, for example. The remaining positively driven cylinders 07; 08; 09; 31 and/or rollers 33 of printing assembly 02 can be driven by drive motor 56, as described in reference to FIG. 4. In the preferred embodiment, drive motor 69 is embodied as controllable and/or adjustable with respect to speed. For the at least speed-controlled operation, a drive controller 73 is also situated upstream of drive motors 69 of the wiping cylinder, for example.

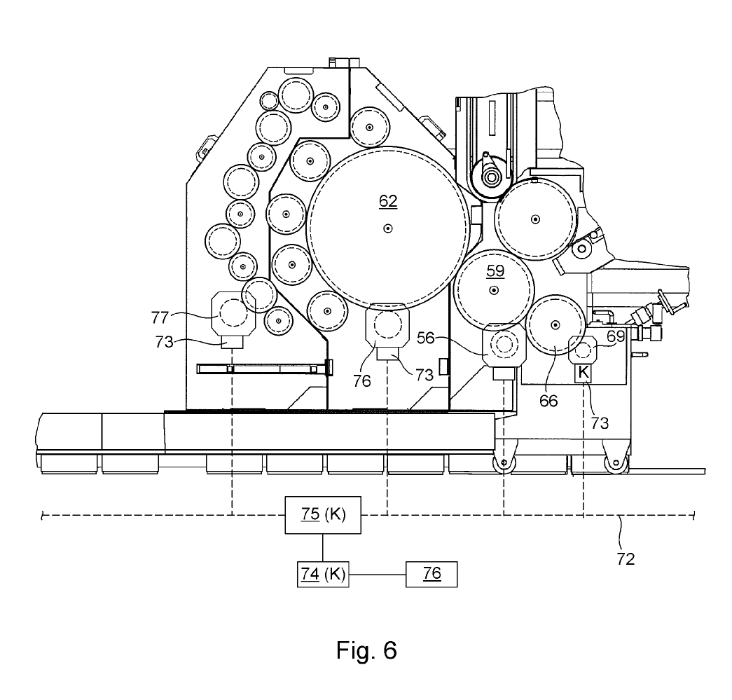

Drive controller 73 of the at least one drive motor 56 that drives printing unit cylinders 07; 08; 09 receives its specifications, e.g. speed or rpm specifications, for operation of the assigned drive motor 56 for example via a signal line 72, e.g. a network 72, from a press control system 74, in particular from a drive control system 75 that is part of press control system 74 or linked thereto in terms of signals. For example, drive control system 75 converts a specification defined manually or via press control system 74 into a target specification for the time-dependent rotational angle position and/or rotational speed, for example, of the connected drive or the connected drives. Press control system 74, or drive control system 75 which is part thereof, can provide a corresponding specification that defines the speed or the course thereof, or a command that triggers a travel route along a ramp, via the same network 72 or via another signal connection, e.g. from a control console 76 (see, e.g., FIG. 4, FIG. 5 or FIG. 6). In the case of a separate wiping cylinder 38 that is driven via drive motor 69, drive motor 69 that drives the wiping cylinder, or drive controller 73 of press control system 74 that is assigned to said drive motor 69, likewise receives its specifications, e.g. speed or rotational speed specifications, via the same or an additional signal line. In a storage means of press control system 74, or of drive control system 75, which is contained therein or connected thereto, or in one of drive controllers 73, a correlation K, in particular a ratio of the rotational speeds of the two drive motors 56; 66, can be predefined such that, during operation, said rotational speeds are in a defined rotational speed ratio to one another, in particular in a rotational speed ratio that is not equal to 1. The ratio and/or the correlation are preferably such that an aforementioned tangential relative speed is present.

The correlation K or the ratio can be provided as a permanently stored, but preferably modifiable—e.g. for adjustment purposes—factor K that determines the ratio, in a storage means of press control system 74 and/or drive control system 75 or some other control means 78 (see below). When the factor is modified, the aforementioned tangential relative speed can be varied. This transmission factor can be taken into consideration when specifying the target value to be supplied to the drive controllers 73.

In another variant, the factor can be considered in drive controller 73 of one of the two drive motors 56; 69, e.g. drive motor 69 assigned to wiping cylinder 38, in terms of the so-called electronic transmission factor, wherein the same rotational speed and/or speed specification is supplied to drive controllers 73 of drive motors 56; 66 that drive forme cylinder 07 and wiping cylinder 38. In this case, control signals can be supplied to the drive controller 73 or the drive controllers 73 via the same signal line 72 or via an additional signal line, by means of which the parameters of the drive controller or controllers 73, e.g. the parameters of the electronic transmission factor, can be adjusted with respect to the aforementioned factor that determines the correlation K.

In an embodiment particularly for the case of a printing assembly 02 that can be divided into a plurality of printing unit sections, at least for the printing unit cylinders 07; 09 of the first printing unit section, at least one drive that is mechanically independent of the drive of cylinders 08; 31 of the second printing unit section is provided by a drive motor 76. Drive motor 76 can be arranged fixed onto frame 43; 43.2 that supports ink collecting cylinder 08, for example. Wiping cylinder 38 can be driven in the aforementioned manner by drive motor 56 or by dedicated drive motor 66. Drive gears 59; 62 of forme and ink collecting cylinders 07; 08 are not in drive connection and are disposed, for example, in two drive planes that are axially offset from one another. The same applies to the case of the mechanically independently driven wiping cylinder 83 for the optionally provided drive gears 59, 66 of forme and wiping cylinders 07; 38.

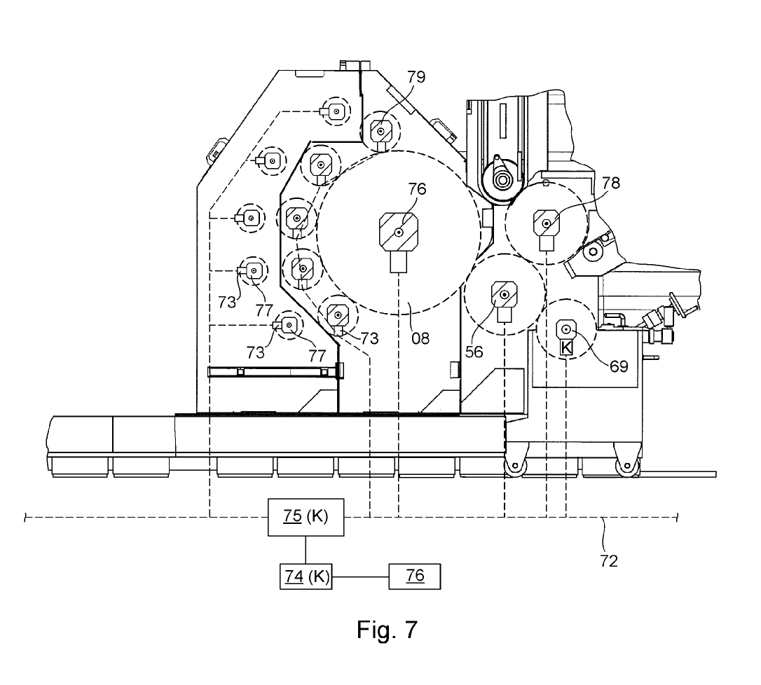

The separable drive connection and the provisions associated therewith between printing couple cylinders 07; 09 of the first printing unit section and printing couple cylinders 08; 31 of the second printing unit section can be dispensed with (see, e.g. FIG. 6 and FIG. 7). In principle, in one alternative of drive gears 63, stencil cylinders 31 can be driven in the aforementioned manner on inking units 29. In the alternative that is preferred here, however, for the inking units 29, particularly for the ink fountain rollers 33, at least one drive that is mechanically independent of the drive of cylinders 08; 31 of the second printing unit section is provided by at least one drive motor 77, whereby the cost that is associated with a separable mechanical drive connection between second and third printing unit sections can also be eliminated in this case. Drive motor 77 can be disposed fixed to frame 43; 43.3 that supports inking units 29, for example.

In the case in which ink collecting cylinder 08 is or can be driven operationally by a drive motor 76 that is mechanically independent from drive motor 56 of printing forme cylinder 07, when frame section 43.2 of the second printing couple section has been backed away, a motorized packing change can be carried out on multiple-sized, preferably quadruple-sized ink collecting cylinder 08, without the need for auxiliary drives. Furthermore, if at least one drive motor 56; 76; 77; 78; 79 and at least one drive connection are provided for the printing unit section in question, between two positively driven cylinders 07; 08; 09; 31; 38 and/or rollers 33 of printing assembly 02 assigned to said printing unit section, a closed gearbox assigned to only this printing unit section and embodied, for example, as a lubricant or oil chamber may be provided.

In an—at least substantially—oil-free embodiment, at least each of the cylinders 07; 08; 09; 31, e.g. the forme cylinder, the impression cylinder, the ink collecting cylinder and the stencil cylinder 07; 08; 09; 31, to be driven true-to-register, i.e. in a defined relative angular position is assigned a dedicated, in particular angular position-controllable drive motor 56; 76; 78; 79 (e.g. indicated in FIG. 7 by hash marks), in each case preferably a so-called torque motor, and/or is driven with the rotor engaged axially on the relevant cylinder 07; 08; 09; 31. In other words, the drives comprise the respective drive motor 56; 76; 78; 79 and an assigned drive controller 73 configured for angular position control. This drive controller or some of these drive controllers 73 can also be parts, e.g. processes, of a control device, e.g. a frequency converter, which is embodied with means for multi-axis application. Inking units 29, in particular the ink fountain rollers 33 thereof, can likewise be embodied as comprising a common drive motor 77, which is angular position-controllable or speed-controllable as described above, or each can preferably be embodied as an angular position-controllable or at least speed-controllable drive motor 77, preferably as so-called torque motors or electric motors that are excited by permanent magnet. They can be driven with the rotor engaging axially on roller 33. At least speed-controllable drive motors are shown by way of example without fill-in in FIG. 7.

Wiping cylinder 38 can likewise be embodied as an angular position-controllable or at least speed controllable drive motor 79, preferably as a so-called torque motor, and/or can be driven with the rotor engaging axially on cylinder 39.

Drive motors 56; 66; 76; 77; 78; 79 as described in the above embodiment examples preferably are not auxiliary drives by which the relevant cylinders 07; 08; 09; 31; 38 and/or rollers 33 are driven merely for maintenance and/or setup work, for example, but for driving the relevant cylinders 07; 08; 09; 31; 38 and/or rollers 33 in groups or individually, both for setup operation, and during production operation.

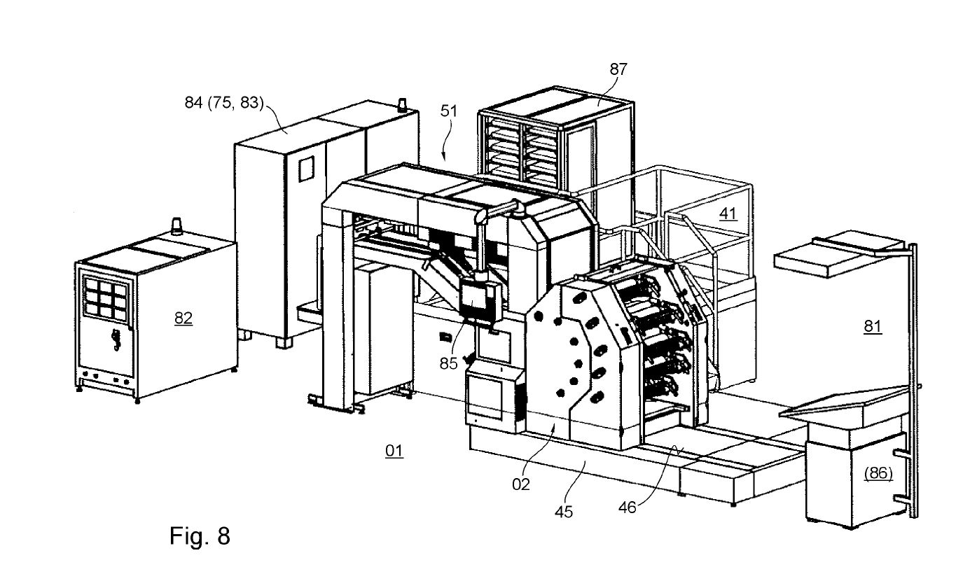

To ensure correlated and/or synchronized driving at every operating speed, between the mechanically unconnected drive motors 56; 66; 76; 77; 78; 79, drive controllers 73 of the two, three, four or more of the angular position-controllable and/or speed-controllable drive motors 56; 66; 76; 77; 78; 79 of one of the aforementioned multiple-motor embodiments are interconnected via signal connection 72, which guides a so-called electronic guide axis in this embodiment, and/or are connected to drive control system 75, which determines the guide axis movement as a drive master. In contrast to the illustration of FIG. 6 and FIG. 7, the latter could be provided by a drive control system assigned to one of the drive controllers and functioning as a master, or preferably by the separately provided drive control system 75, as shown. The drive control system 75 that defines the guide axis movement receives its specifications, e.g. speed or rotational speed specifications, from press control system 74. A corresponding specification or a command that triggers a travel routine along a ramp can be specified to press control system 74 via control console 76, for example (see, e.g. FIG. 8). In addition to the guide axis signal, control signals which define or can define a required relative position and/or a transmission behavior of the drive in question can be sent to the drive controllers via the same signal line 72 or an additional signal line. In particular, control signals can be supplied, which can be used to adjust the parameters of a plurality of or all of the drive controllers 73, e.g. the parameters of a specific electronic transmission factor and/or a specific relative angular position offset can be adjusted. The above-mentioned correlation K can be used to determine the specific transmission factor for the forme cylinder drive and/or the wiping cylinder drive.

In addition to printing assembly 02, feeding device 03 and product delivery unit 06 and a connection to a control console 81 assigned to this printing press 01 or optionally to a plurality of printing presses, a temperature control device 82 is provided for printing press 01, by which the temperature of one or more components of printing assembly 02 can be controlled. For example, ink fountain rollers 33 and/or stencil cylinders 31 and/or ink collecting cylinder 08 and/or forme cylinder 07 and/or wiping cylinder 31 are connected to temperature control device 82 for the purpose of temperature control. The circuits and/or processes that are required for controlling printing press 01 can be implemented in corresponding control means 83, e.g. in one or more control means 83 embodied as programmable logic controllers (PLC) and/or as computing and/or data processing units, which are housed, for example, in a switchgear cabinet 84. If provided, the processes of press control system 74 and/or drive control system 75 can also be provided therein. Control means 83 of switchgear cabinet 84 are connected in terms of signals to a computer and/or data processing means 86 assigned to control console 81, for example, in which the processes or portions of the processes that relate to press control system 74 can be implemented.

Finally, a delivery device 87, also called a paternoster 87, can be provided for printing press 01, in which—to prevent blocking of the freshly printed, as yet undried sheets 04 as a result of excessive pressure—smaller stacks of printed sheets 04 can be held on intermediate surfaces arranged one above the other.

The compact embodiment of the press with the sheet infeed unit and sheet delivery unit arranged on the same side now allows the control console 81 to be disposed at one end of printing press 01, without thereby enlarging the path unacceptably.

To save press operators from having to travel unnecessary distances, in addition to control console 81, a control panel 85 close to the printing unit, i.e. lying closer to print position 14 of printing assembly 02 than control console 81, can be provided, on which at least basic functions for operating printing assembly 02 can be controlled and/or information regarding the status of printing assembly 02 can be output.

Printing press 01, also referred to as a compact press or small-format press or small run press, is preferably provided in a print shop together with one or particularly more printing presses 88; 96 of another type and/or another format. These printing presses 01; 88; 96 can be provided in the same press room or also in different press rooms of the same print shop and/or printing system.

Thus said printing press is situated, for example, in a print shop or printing system, in which, in addition to the above-described compact press, in particular compact gravure printing press 01, a printing press 88 embodied as gravure printing press 88, in particular for security printing, with a gravure assembly 91 having a single- or preferably multiple-sized, in particular triple-sized forme cylinder 91, which is embodied as having a circumferential length that is larger than the circumferential length of forme cylinder 07 of first printing press 01, i.e. compact gravure printing press 01, in particular at least 50% larger, i.e. at least 1.5-times the circumferential length. It also has a larger printing width than forme cylinder 07 of the compact printing unit, in particular at least 1.5 times the printing width. Gravure printing press 88 is preferably embodied as having a forme cylinder 91, the maximum usable printing area of which is at least twice, preferably three times as large as that of the first printing press 01. In this manner, conversely, an overall printing area that is smaller than that of printing press 01 that is provided for large run or high-volume printing, i.e. at most one half, preferably at most one third of the entire printing area, can be used in compact printing press 01, which is advantageous particularly for printing smaller runs and/or so-called proof printing, i.e. a test printing in advance of a high-volume print run. In the latter, the engraving of the printing pattern, e.g. a bank note, which is to be provided for a later printing run, e.g. also referred to as high-volume printing, and/or is to be provided in a large number on the same printing forme 21 on a gravure printing press having a correspondingly large output, is checked and developed.

The printing system and/or print shop thus preferably comprises a first printing press 01 embodied, e.g. for proof printing or for printing smaller print runs, having a printing assembly 02 embodied for gravure printing, the forme cylinder 07 of which is embodied as single-sized for printing one printing length D per revolution or preferably as double-sized for printing two printing lengths D, and which cooperates for its inking with an ink collecting cylinder 08 which is preferably quadruple-sized, said printing system also comprising a second printing press 88, e.g. embodied as a printing press for production run printing and/or high-volume printing, having a printing assembly 89 embodied for gravure printing, the forme cylinder 91 of which is embodied as at least double-sized for printing two printing lengths D′, or preferably as triple-sized, e.g. having three segments and/or printing lengths D′ for printing three printing lengths D′ per revolution, and which cooperates for its inking, for example, with an ink collecting cylinder 92 of equal size, for example, preferably triple-sized, e.g. having three segments and/or printing lengths D′, wherein the printing length D′ of the second printing press 88 corresponds to at least 1.5 times, preferably twice the size of the first printing press 01. Ink collecting cylinder 92 is inked up, as in the case of the first printing press 01, by a plurality of stencil cylinders 93, in particular by at least four, preferably five. In this case, forme cylinder 91 and/or ink collecting cylinder 92 and/or an impression cylinder 94 preferably each have a circumference having a whole number multiple of the circumference of stencil cylinder 93, e.g. at least 3-times the circumferential length thereof. Preferably, they have the same whole number multiple. The number o of stencil cylinders 93 provided in the first and second gravure printing presses 01; 88 is preferably the same, preferably five.

In a further enhancement, the printing system and/or print shop embodied for security printing, in particular bank note printing, comprises, in addition to the first gravure printing press 01 embodied, e.g. for proof printing or for printing small print runs, and preferably in addition to an above-mentioned second gravure printing press 88 embodied for production printing, a third printing press 96, e.g. offset printing press 96, having a printing assembly 97 provided for printing according to a printing method other than the gravure printing method, e.g. for printing according to an offset printing method. In a preferred and illustrated case, the third printing press 96 is a printing press for production printing and/or high-volume printing, configured for printing the printing material, e.g. printing material sheets, on at least one side by a printing unit, preferably on both sides simultaneously by two printing units in an offset method. The printing unit embodied as offset printing unit in this case comprises at least one, preferably a plurality of single-sized forme cylinders 98, having, e.g. a segment and/or a printing length which is or are embodied for printing only one printing length per revolution, and which cooperates for its inking, e.g. with a preferably multiple-sized, in particular triple-sized offset or transfer cylinder 99 having e.g. three segments and/or printing lengths.

Forme cylinder 98 has a larger printing width than forme cylinder 07 of compact printing press 01, in particular at least 1.5 times or preferably twice the printing width. For the preferred case in which a second printing press 88 is also provided, the maximum printing length of printing assembly 97 or of forme cylinder 98 of the third printing press 96 preferably corresponds to the maximum printing length of printing assembly 89 or of forme cylinder 91 of second printing press 88.

In the production of securities, e.g. bank notes, in production printing and/or high-volume printing, sheets can be printed in sequence by a first of the two printing presses 88; 96 embodied for production printing and/or by the other of the two printing presses 88; 96 embodied for production printing in two different printing methods. For the process of preparing for a new production run, which is time-consuming due to the need to produce and develop the gravure printing formes, it is not necessary to interrupt a production run on the press line that comprises the two printing presses 88; 96. Moreover, for developing and producing the engraving that represents the motif, it is not necessary to print an unnecessarily large printing forme 21 and/or an unnecessarily large sheet 04. The so-called proof printing can be carried out on the compact press. In place of or in addition to this use as a proof printing machine, printing press 01 which is embodied, for example, as a compact printing press 01 can also be configured for smaller production runs and/or smaller printing motifs. For example, printing press 01 may be operated for producing sheets 04 of postage stamps or sheets of labels or sheets of stock certificates.

While preferred embodiments of a gravure printing press and a printing system having a gravure printing press have been set forth fully and completely hereinabove, it will be apparent to one of skill in the art that various changes could be made without departing from the true spirit and scope of the present invention which is accordingly to be limited only by the appended claims.

What is claimed is:

1.-22. (canceled)

23. A gravure printing press comprising a printing assembly (02) having a printing forme cylinder (07) which is double-sized in terms of the number I (IεIN) of copies that can be printed during one revolution, i.e. where I=2, said printing forme cylinder, in the thrown-on position, forming a print position (14) with an impression cylinder (09) which is double-sized in terms of the number m (mεIN) of copies that can be printed during one revolution, i.e. where m=2, having a wiping cylinder (38) which, in the thrown-on position, cooperates with the printing forme cylinder (07), having an ink collecting cylinder (08) which, in the thrown-on position, cooperates with the printing forme cylinder (07), and having a plurality of stencil cylinders (31) which, in the thrown-on position, cooperate one after another with the ink collecting cylinder (08) on the circumference thereof and can each be inked up by way of at least one inking unit (29), characterized in that the ink collecting cylinder (08) is configured as having a circumference which is a whole number multiple of the circumference of the printing forme cylinder (07), i.e. as having an n-fold circumference in relation to that of the printing forme cylinder (07), where nεIN and n>1, wherein the circumferential length of the printing forme cylinder (07) is at most 1,600 mm.

24. The gravure printing press according to claim 23, characterized in that the printing forme cylinder (07) has a circumference having a circumferential length which is the same as or twice the circumference of the stencil cylinders (31), and in that the ink collecting cylinder (08) has a circumference having a circumferential length which is at least four times the circumference of the stencil cylinders (31).

25. The gravure printing press according to claim 23, characterized in that the printing forme cylinder (07) comprises two segments distributed evenly one in front of the other in the circumferential direction, on each of which a printing forme can be disposed.

26. The gravure printing press according to claim 23, characterized in that the ink collecting cylinder (08) is embodied as quadruple-sized in terms of the number k (kεIN) of copies that can be printed during one revolution, i.e. where k=4, and/or the stencil cylinder (31) is embodied as single-sized in terms of the number I (jεIN) of copies that can be printed during one revolution, i.e. where j=1.

27. The gravure printing press according to claim 23, characterized in that the printing forme cylinder (07) is embodied for receiving and for holding two releasable printing formes (21) on its circumference, one in front of the other in the circumferential direction, and/or the ink collecting cylinder (08) is embodied for receiving and/or for holding four releasable rubber blankets (23) on its circumference, one in front of the other in the circumferential direction, and/or the stencil cylinder (31) is embodied for receiving and/or for holding only one stencil (37) on its circumference in the circumferential direction.

28. The gravure printing press according to claim 23, characterized in that the printing forme cylinder (07) has a maximum width that can be used for printing of at most 600 mm, preferably at most 500 mm, and/or a maximum area on the configured and operationally ready printing forme cylinder (07) that can be used for printing of at most 0.40 m² and/or the circumferential length of the printing forme cylinder (07) is at most 1,400 mm.

29. The gravure printing press according to claim 23, characterized in that a number o (oεIN) of at least four, i.e. o≧4, stencil cylinders (31), preferably five, i.e. o=5, stencil cylinders (31), are arranged one in front of the other on the circumference of the ink collecting cylinder (08).

30. The gravure printing press according to claim 23, characterized in that the ink collecting cylinder (08) and the stencil cylinders (31) are provided in a frame (43.2), which can be backed away from a frame (43.1) that supports the printing forme cylinder (07) into a maintenance position, such that, in the maintenance position, a space (44) is formed between a first and a second printing unit section and/or between a first and a second frame (43.1; 43.2), which space allows direct access to the circumferential surface of the ink collecting cylinder (08) and to the circumferential surface of the printing forme cylinder (07).

31. The gravure printing press according to claim 23, characterized in that the inking units (29) that cooperate with the stencil cylinders (31) in the thrown-on position are provided in a frame (43.3), which can be backed away from a frame (43.1; 43.2) that supports at least the ink collecting cylinder (08) and the stencil cylinder (31) into a maintenance position, such that in the maintenance position, a space (49) is formed between a first printing unit section, which comprises the ink collecting cylinder (08), and a printing unit section which comprises the inking units (29), and/or between the stencil cylinders (31) and the inking units (29) and/or between a frame (43.1; 43.2) that supports the ink collecting cylinder (08) and a frame (43.3) that supports the inking units (29), which space allows direct access to the circumferential surface of the stencil cylinders (31) and to the inside of the inking units (29).

32. The gravure printing press according to claim 23, characterized in that the circumference of the wiping cylinder (38) is smaller than the circumference of the printing forme cylinder (07), but is larger than one-half its circumference.

33. The gravure printing press according to claim 23, characterized in that, during production, the wiping cylinder (38) is driven in the same direction of rotation as the printing forme cylinder (07) and/or, during operation, for cleaning purposes, the wiping cylinder dips into the washing fluid of a fluid container (39) and/or is driven by a drive motor (66) which is mechanically independent of the drive of the printing forme cylinder (07).

34. The gravure printing press according to claim 23, characterized in that the wiping cylinder (38) and a fluid container (39) are disposed on and/or in a frame (48), which can be backed away as an entire unit from the printing forme cylinder (07) and/or from a frame (43; 43.1) that houses the printing forme cylinder (07) into a maintenance position, in which a space (54) is formed between a printing unit section that comprises the printing forme cylinder (07) and the wiping cylinder (38) and/or between the frame (43, 43.1) that supports the printing forme cylinder (07) and the frame (48) that supports the fluid container (37), and/or between the circumferential surface of the wiping cylinder (38) and the circumferential surface of the printing forme cylinder (07), which space allows direct access to the circumferential surface of the printing forme cylinder (07) and to the fluid container (37) and/or to the circumferential surface of the wiping cylinder (38).

35. The gravure printing press according to claim 31, characterized in that the frames (43.1; 43.2; 43.3; 48) which in the maintenance position are and/or can be backed away from one another are securely coupled to one another in the working position, in particular they are connected to one another via a locking mechanism, wherein at least one sensor that monitors the coupling, in particular the locking mechanism, is preferably provided, along with a control device which is connected in terms of signals to the at least one sensor, and which has a logic circuit that is implemented in said control device and monitors the signal status of the at least one sensor and which, in the case of a negative result, prevents the start-up of the press.

36. The gravure printing press according to claim 31, characterized in that the frames (43.1; 43.2; 43.3; 48) which in the maintenance position are and/or can be backed away from one another, opening up the space between them, in the working position together form a substantially closed frame (43), that is to say they adjoin one another such that they do not allow free access between the two frames (43.1; 43.2; 43.3; 48) that can be backed away from one another.

37. The gravure printing press according to claim 23, characterized in that the forme cylinder (07) and the wiping cylinder (38) are driven mechanically independently of one another by two drive motors (56; 69), and in that, in a storage means of a press control system or drive control system (74; 75) or of a drive controller (73) of at least one of the two drive motors (56; 69), a ratio and/or a correlation between the target speeds of the two drive motors (56; 66) is specified, such that, during operation, they are always in a defined, preferably adjustable speed ratio relative to one another, and in that the drive control system is preferably configured in such a way, and the correlation (K), in particular the ratio, between the target speeds is specified in the storage means, taking into consideration the circumferential lengths, such that, in the nip point between printing forme cylinder and wiping cylinder (07; 38), a tangential relative speed is present, which corresponds to at least twice the circumferential speed of the printing forme cylinder (07).

38. The gravure printing press according to claim 23, characterized in that the wiping cylinder (38) is driven in parallel with the driving of the printing forme cylinder (07) by a gear wheel (59) that is driven by a drive motor (56), directly or via an even number of intermediate gears, on a gear wheel (66) which is rotationally fixedly connected to the wiping cylinder (38), or is driven serially by the drive motor (56) via the drive gear (59) of the printing forme cylinder (07) and an uneven number of intermediate gears (67) on the drive gear (66) of the wiping cylinder (38), and preferably in that the drive train to the journal of the printing forme cylinder (07) and to the journal of the wiping cylinder (38) is embodied in terms of its rolling ratios and/or by an additional gear set (68) such that, taking into consideration the active outer circumference of the wiping cylinder (38) and the active outer circumference of the loaded printing forme cylinder (07), it rotates in the same direction of rotation as the forme and wiping cylinders (07; 38) and a tangential relative speed is present in the nip point which corresponds to at least twice the circumferential speed of the printing forme cylinder (07).

39. The gravure printing press according to claim 23, characterized in that printing material to be printed is infed into the printing assembly by a first conveyor system (12) from the same side of the printing assembly (02) on which the printed printing material is removed by a second conveyor system (16) after printing.

40. The gravure printing press according to claim 23, characterized in that the forme cylinder (07) and the ink collecting cylinder (08) can be and/or are driven mechanically independently of one another by different, in particular angular position-controllable drive motors (56; 76), and in that preferably one roller (33) of at least one of the inking units (29) can be and/or is driven mechanically independently from the ink collecting cylinder (08) and/or the stencil cylinders (31) by one particularly at least speed-controllable drive motor (77).

41. A printing system, in particular for printing sheets of securities, comprising a first gravure printing press (01) according to claim 23 and comprising at least one additional second printing press, embodied as a gravure printing press (88) and having a printing forme cylinder (91), an ink collecting cylinder (92) and a plurality of stencil cylinders (93) which, in the thrown-on position, cooperate one after another with the ink collecting cylinder (92) on the circumference thereof, wherein the printing forme cylinder (91) and the ink collecting cylinder (92) have the same circumference having at least triple the circumferential length of the circumference of the stencil cylinders (93).

42. The printing system according to claim 41, characterized in that the printing forme cylinder (91) of the second printing press (88) has a maximum usable printing area that corresponds to at least twice the maximum usable printing area of the first printing press.

43. The printing system according to claim 41, characterized by a third printing press (96) which comprises a printing assembly (97) for printing according to a different printing method from the gravure printing method, having a printing forme cylinder (98), in particular a printing assembly (97), with at least one offset printing unit.

44. The printing system according to claim 43, characterized in that a maximum printing width of the printing forme cylinder (91) of the second printing press (88) and/or the maximum printing width of the printing forme cylinder (98) of the third printing press (96) is at least twice as large as the maximum printing width of the printing forme cylinder (07) of the first printing press (01).

45. The gravure printing press or printing system according to claim 23, characterized in that copies are defined as the printing lengths that are or can be provided one behind another in the circumferential direction of the relevant cylinder (07; 08; 09; 31), which are understood as the length in the circumferential direction which, for the configured printing assembly (02), corresponds to the maximum uninterrupted print image length to be printed by the printing assembly (02), as viewed in the direction of transport.
